(19) United States
(12) Patent Application Publication
(10) Pub. No.: US 2013/0124139 A1
(43) Pub. Date: May 16, 2013

(54) METHOD AND A NETWORK NODE FOR LOCALIZATION OF A USER EQUIPMENT

(71) Applicants: Fredrik GUNNARSSON, Linkoping (SE); Fredrik GUSTAFSSON, Linkoping (SE)

(72) Inventors: Fredrik GUNNARSSON, Linkoping (SE); Fredrik GUSTAFSSON, Linkoping (SE)

(73) Assignee: TELEFONAKTIEBOLAGET L M ERICSSON (PUBL), Stockholm (SE)

(21) Appl. No.: 13/608,672

(22) Filed: Sep. 10, 2012

Related U.S. Application Data
(60) Provisional application No. 61/560,910, filed on Nov. 17, 2011.

(30) Foreign Application Priority Data
Nov. 15, 2011 (EP) 11189146.1

(51) Int. Cl. G06F 15/00

(52) U.S. Cl. 702/150

(57) ABSTRACT

A method is disclosed that includes receiving one or more first localization related measures for a user equipment node at a first localization measurement time, and receiving at least one or more second localization related measures for the user equipment node at a second localization measurement time. The localization related measurements are included in a trace of localization related measurements for the user equipment node from the first localization measurement time to the second localization measurement time. A location for the user equipment at a single time instant in a time interval between the first localization measurement time and the second localization measurement time is estimated from the trace.

### FIELD OF THE INVENTION

The present invention relates to a method and a network node for improved localization of a user equipment node in a wireless network. The invention also relates to use of the localization method in generating position estimates for a user equipment measurement report.

### BACKGROUND OF THE INVENTION

The architecture of present day mobile network includes a radio access network, a core network and user equipment connecting to the radio access network. The radio access network includes radio base stations or nodes for setting up the connection to the user equipment.

Whilst the nodes of the radio access network mainly can be considered as stationary with fixed location, the user equipment is mobile and may take basically any position within the network. Planning, configuring, optimizing, and maintaining a radio access network, the mobile operator must ensure a radio propagation behavior in the system that corresponds to the location of user equipment nodes in the network. Today, operators resort to planning tools to dimension and plan their networks according to a specific business strategy. The approach based on planning tools and prediction is, however, not fully accurate. Reasons for the inaccuracies are imperfections in the used geographic data, simplifications and approximations in the applied propagation models, and changes in the environment, e.g., construction/demolition or seasonal effects (foliage changes). Furthermore, changes in the traffic distribution and user profiles can lead to inaccurate prediction results. The above mentioned shortcomings force operators to continuously optimize their networks using measurements and statistics, and to perform drive/walk tests. Drive/walk testing provides a picture of the end user perception in the field and enables the operator to identify locations causing poor performance and their corresponding cause (e.g., incorrect tilt or handover settings). Drive/walk tests are, however, not ideal since only a limited part of the network can be analyzed due to access restrictions and the cost and time involved. Further, only a snapshot in time of the conditions in the field is captured. Wireless network operators today have considerable manual effort in network management, e.g., configuring the radio access network. These manual efforts are costly and consume a great part of operational expenditures (OPEX).

e-UTRAN (evolved UMTS Terrestrial Radio Access Network) is a future wireless access network standard optimized for packet data and providing higher data rates. An important E-UTRAN requirement from the operators' side is a significant reduction of the manual effort in network management for this future wireless access system. This involves automation of the tasks typically involved in operating a network, e.g., planning, verification through, e.g., drive/walk testing, and optimization.

A method for improving network management in e-UTRAN is to use the user equipment (UE) reports. The UE can report anything that can be configured via the radio resource control measurement control and reporting procedures. A standardization of such UE reports is carried out within 3GPP. The user equipment node collects data to determine observed service quality, e.g., RF signal strength, along with the location where the measurement was taken.

A prior art localization framework in the E-UTRAN is based on transactions via a serving mobile location centre (SMLC) or an enhanced SMLC (E-SMLC). The positioning protocols used to request location information from the SMLC operate on a transaction basis, which means that a request-response exchange is executed between the client requesting the location information and the server providing the location response. Thus, each localization requires its own request. An alternative localization method is based on snapshot measurements from the user equipment node and one or more base stations (eNB). However, the location of a user equipment node based on a snapshot does not provide a sufficiently accurate localization for the UE reporting purposes.

The approaches and presently recognized problems described above in this section could be pursued, but are not necessarily approaches and/or problems that have been previously conceived or pursued. Therefore, unless otherwise clearly indicated herein, the approaches and problems described above in this section are not prior art to claims in any application claiming priority from this application and are not admitted to be prior art by inclusion in this section.

### SUMMARY

It is an object of some embodiments of the present invention to provide improved methods and arrangements for localizing user equipment node with improved accuracy.

The object may be achieved by a method in a network node. The method enables localization at a single time instant of a user equipment node in the wireless network. In an embodiment of the invention a first localization measurement time and a second localization measurement time are included amongst a plurality of localization measurement times, wherein a specific time instant is comprised in a time interval from the first localization measurement time to the second localization measurement time. A first localization related measure is received for the user equipment node at the first localization measurement time and one or more second localization related measures are received for the user equipment node at the second localization measurement time. A trace of localization related measures are formed for the user equipment node over the time interval from the first localization measurement time to the second localization measurement time. The location of the user equipment node at the single time instant is estimated from a localization related measure represented in the trace.

The object may also be achieved by a network node in a mobile network wherein the inventive method may be performed. The network node comprises means for receiving localization related measures for a user equipment node at a localization measurement time. Means for forming a trace of localization related measures for the user equipment node are included in the network node. The network node further include means for estimating the location of the user equipment node at a single time instant from a localization related measure represented in the trace.

It is another object of some embodiments of the invention to improve user equipment measurement reporting by improving a position estimate included in such reports.

This object may be achieved through use of the inventive localization method for generating a position estimate to include in a user equipment measurement report.

The invention may enable more efficient use of trace information to perform network-based localization of user equipment nodes.

### BRIEF DESCRIPTION OF THE DRAWINGS

FIG. 1 A radio system architecture.

FIG. 2 A network management system.

FIG. 3 Flow chart of an embodiment of the embodiments of a method according to some embodiments.

FIG. 4 An embodiment of a network node architecture.

### DETAILED DESCRIPTION

In the following, embodiments of the invention are described for e-UTRAN, the air interface of the 3GPP's (3^{rd} Generation Partnership Project) LTE (Long Term Evolution) upgrade path for mobile networks. However, it is noted that the invention can be applied to other types of networks and standards, e.g., GSM and UTRAN. E-UTRAN is used merely as an exemplifying standard to illustrate various embodiments of the invention.

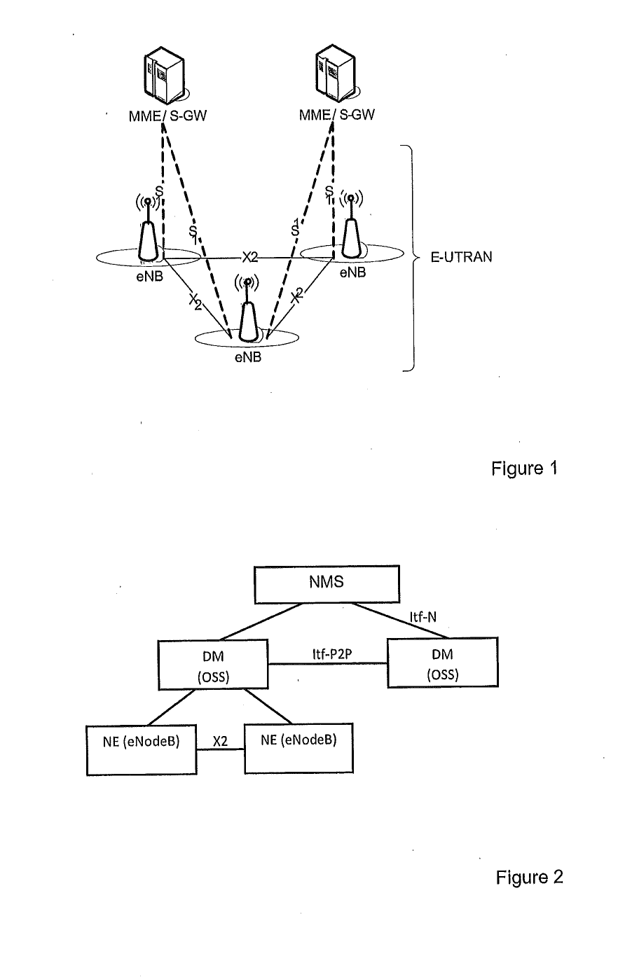

FIG. 1 discloses the architecture of such a Long Term Evolution LTE radio system. The E-UTRAN is made up of eNB nodes, which may be connected to each other. Each eNB contains at least one radio transmitter, receiver, control section and power supply. In addition to radio transmitters, and receivers, eNBs contain resource management and logic control functions that allow eNBs to directly communicate with each other via an X2 interface. eNB functions include radio resource management—RRM, radio bearer control, radio admission control—access control, connection mobility management, resource scheduling between UEs and eNB radios, header compression, link encryption of the user data stream, packet routing of user data towards its destination (usually to the EPC or other eNBs), scheduling and transmitting paging messages (incoming calls and connection requests), broadcast information coordination (system information), and measurement reporting (to assist in handover decisions).

Each eNB is composed of an antenna system (typically a radio tower), building, and base station radio equipment. Base station radio equipment consists of RF equipment (transceivers and antenna interface equipment), controllers, and power supplies.

User equipment nodes in the radio network connect to the radio access network through the eNB nodes. User equipment nodes—UE—can be many types of devices ranging from simple mobile telephones to digital televisions. In the initial cell selection process, no knowledge about RF channels carrying an E-UTRA signal is available in the user equipment. In this case the UE scans the E-UTRA frequency bands to find a suitable cell. Only the cell with the strongest signal per carrier will be selected by the UE.

Whilst communicating in the network, the user equipment nodes may be requested to report the observed service quality along with the locations where the measurements are taken. The reports are denoted as user equipment reports, UE reports. The UE reports are received in a network management system NMS according to FIG. 2. The node elements (NE), also referred to as eNodeB or eNB, are managed by a domain manager (DM), also referred to as the operation and support system (OSS). The user equipment reports relate to transmissions from a node element (NE) antenna.

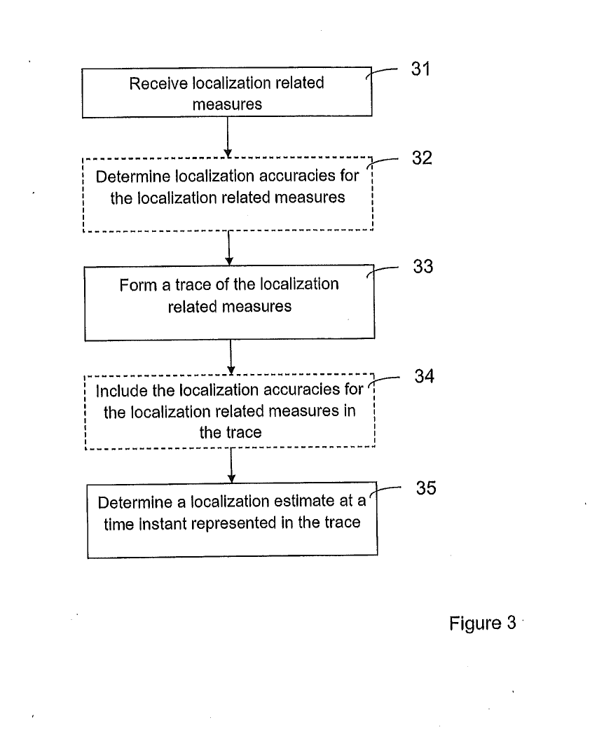

The localization of a user equipment node may be established by an embodiment of a localization method disclosed in the flowchart in FIG. 3.

Localization related measures are determined by a base station for a user equipment node in the coverage area of the base station. Such localization related measures may include received signal strength or other suitable localization related measures, e.g., a round-trip time estimate from user equipment in one or more sectors at the same base station or a time difference of arrival reported by a user equipment considering pairs of base stations. The localization related measures may preferably also include measurements from the user equipment that reported to the base station. The localization related measures could include information on received signal strength from a user equipment node measured on one or more sectors at the same base station. This information may be used together with antenna information to determine possible angles between the user equipment node and the base station. The localization related measures could also include a time difference of arrival reported by a user equipment considering pairs of base stations. The localization related measures are transferred to a network management system. In a first step 31 in the network management system one or more first localization related measures for the user equipment node at a first localization measurement time (t1) and one or more second localization related measures for the user equipment node at a second measurement time (t2) are received.

In an optional step 32, localization accuracies are determined for localization related measures. When the localization related measurements are based on received signal strength measurements from the user equipment in combination with antenna information, the localization accuracy information could be an angle estimation accuracy derived from the received signal strength and the antenna information.

In another embodiment of the invention, wherein the localization related measurements relate to round-trip time estimates from one or more sectors of a base station, the localization accuracies are based on base station estimation information, such as uplink synchronization accuracy and user equipment processing assumptions, for example concerning the assumed synchronization accuracy in the UE with respect to received downlink signals.

In an embodiment of the invention wherein the localization related measurements are time difference of arrival reported by the user equipment considering pairs of base stations; the localization accuracy is the time synchronization estimation accuracy. The UE synchronizes to two different base stations and compare the difference. The total accuracy is twice the time synchronization accuracy. The localization accuracy can either be assumed or modeled based on reported signal strength and quality per cell. It could also be associated to the mobile capabilities that are signaled to the base station from the mobile during connection establishment.

In step 33, the network management system or the base station forms a trace of the localization related measures from a sequence of measurements, starting at a first localization measurement time (t1) to a second localization measurement time (t2). The time interval from the first localization measurement time (t1) to the second localization measurement time (t2) includes a single time instant (t). In one embodiment, the base station forwards each, or a set of measurements, and the network management system puts together a trace from all received set of measurements. Note that each set of measurement could come from different base stations if the mobile moves around and changes serving base station.

In another embodiment, the serving base station puts together the trace and forwards to the network management system.

The network management system estimates a position of the user equipment at a time instant during the time interval covered by the first localization measurement time (t1) and the second localization measurement time (t2).

Given a trace of T localization measurement, where yᵣ denotes the localization measurement at a particular time step t of the trace, where t=1, . . . , T. The measurement is a vector with elements yₜ⁽ⁱ⁾. The localization measurements trace is denoted y_{1:T}.

Given the localization measurement yₜ, Yₜ denotes the accuracy-related information associated with the localization measurement.

The objective is to estimate the location of the user equipment at time instants during the time interval covered by the localization measurement time instants using the localization and accuracy information. Let the vector x_{τ} denote the information about the user equipment to be estimated using the available information. Examples of elements in this vector include coordinates in the plane as well as velocity including directivity in the plane. This can be expressed as the following function

x_{τ}=f(y_{t1:t2};Y_{t1:t2})

where τ≦t2 and t1≦t2 meaning that the location estimate is based on at least one localization information from a time instant later than τ.

Exemplifying embodiments of such functions include a weighted average, a Kalman smother and a particle smoother.

A basic form of smoothing is via a non-causal finite-impulse response (FIR) filter. Assume that yₜ in fact is a location estimate and Cₜ is the covariance estimate.

The covariance matrix Cₜ with entry (i,j) defined by

Cₜ^{(l,j)}=E{(yₜ⁽ⁱ⁾−E{yₜ^{(i)})(y}ₜ^{(j)}−E{yₜ^{(j)}})}

Element-wise smoothing can for example be implemented as the following exponential smoother with one term from a future time instant and one from a past time instant.

$${\hat{x}}_{t}^{( i )} = \frac{( \frac{α}{{C}_{t - 1}^{( i , i )}} {y}_{t - 1}^{( i )} + \frac{1 - 2 α}{{C}_{t}^{( i , i )}} {y}_{t}^{( i )} + \frac{α}{{C}_{t + 1}^{( i , i )}} {y}_{t + 1}^{( i )} )}{( \frac{1}{{C}_{t - 1}^{( i , i )}} + \frac{1}{{C}_{t}^{( i , i )}} + \frac{1}{{C}_{t + 1}^{( i , i )}} ) ,}$$

$$t = 2 , … , T \text{-} 1$$

Kalman smothering is optimal when the dynamics of the measurement and the movements are linear and subject to additive Gaussian noise.

One common example of such a linear system due to mobility of an object is a model based on random acceleration. This means that the acceleration in the x and y direction is not correlated between time steps and zero-mean Gaussian with variance σₐ². If the state vector

xₜ=[pₓ,p_{y},vₓ,v_{y}]^{T}

and the sample time is Tₛ, then the Aₜ and Bₜ matrices are given by

$${A}_{t} = ( \begin{matrix}1 & 0 & {T}_{s} & 0 \\ 0 & 1 & 0 & {T}_{s} \\ 0 & 0 & 1 & 0 \\ 0 & 0 & 0 & 1\end{matrix} ) , {B}_{t} = ( \begin{matrix}{T}_{s}^{2} & 0 \\ 0 & {T}_{s}^{2} \\ {T}_{s} & 0 \\ 0 & {T}_{s}\end{matrix} ) ,$$

Moreover, the model also includes measurement noise assumptions, such that the measurement errors are uncorrelated between time steps, zero-mean Gaussian with covariance matrix Rₜ.

The model can be summarized as

$${x}_{t + 1} = {A}_{t} {x}_{t} + {B}_{t} {v}_{t}$$

$${y}_{t} = h ( {x}_{t} ) + {e}_{t}$$

$$Var \{ {v}_{t} \} = {Q}_{t} = ( \begin{matrix}{σ}_{a}^{2} & 0 \\ 0 & {σ}_{a}^{2}\end{matrix} )$$

$$Var \{ {e}_{t} \} = {R}_{t}$$

Commonly, the measurement equation is nonlinear in the states (h(xₜ)). This can be handled by estimating a linear model locally around the current state estimate. By partially differentiating with respect to each state, and enter the current state estimate, a linear measurement equation

$${x}_{t + 1} = {A}_{t} {x}_{t} + {B}_{t} {v}_{t}$$

$${y}_{t} = {C}_{t} {x}_{t} + {e}_{t}$$

$${C}_{t} = \frac{\partial h}{\partial x} {\vert}_{x = {x}_{t \vert t - 1}} \\ Var \{ {v}_{t} \} = {Q}_{t} = ( \begin{matrix}{σ}_{a}^{2} & 0 \\ 0 & {σ}_{a}^{2}\end{matrix} ) \\ Var \{ {e}_{t} \} = {R}_{t}$$

The Kalman filter can be seen as a filter in two phases, first a time update and then a measurement update

### Time Update

\hat{x}_{t+1|t}=Aₜ\hat{x}_{t|t}

P_{t+1|t}=AₜP_{t|t}Aₜ^{T}+Qₜ

### Measurement Update:

\tilde{y}ₜ=yₜ−Cₜ\hat{x}_{t|t-1}

Sₜ=CₜP_{t|t|-1}Cₜ^{T}+Rₜ

Kₜ=P_{t|t-1}Cₜ^{T}Sₜ⁻¹

\hat{x}_{t|t}=\hat{x}_{t|t-1}+Kₜ\tilde{y}ₜ

P_{t|t}=(I−KₜC^{t})P_{t|t-1}

Starting from initial assumptions \hat{x}_{0|0} and P_{0|0}. The initial position assumption (first two elements of \hat{x}_{0|0}) could be based on less accurate methods such as the location and antenna direction of the serving cell, the center of gravity of the serving cell, and assumption about the velocity (last two elements of \hat{x}_{0|0}) for example not being mobile meaning a zero velocity. The initial covariance P_{0|0} could be set with respect to those crude estimates, for example reflecting the cell radius as well as how likely that the mobile is stationary.

The Kalman smoother provides an optimal estimate \hat{x}_{t|t2} with t2>t. One example is the Rauch-Tung_Streibel (RTS). It is based on two passes—a forward pass and a backward pass. The forward pass is a regular Kalman filter, but all information per time instant is stored to be used for the calculations backward in time. When the measurement data has been considered first with increasing time, and then backwards with decreasing time, then the estimate of the position and velocity of each time instant is a function of all measurements both associated to earlier time instants and later time instants

Ãₜ=Aₜ⁻¹(I−QₜP_{t+1|t}⁻¹)

\tilde{K}ₜ=Aₜ⁻¹QₜP_{t+1|t}⁻¹

\hat{x}_{t|n}=Ãₜ\hat{x}_{t+1|n}+\tilde{K}ₜ\hat{x}_{t+1|t}

Other embodiments of the inventive method includes generating one or more further localization related measures in the time interval from the first localization measurement time (t1) to the second localization measurement time (t2) in order to improve the accuracy for the trace of localization measurement.

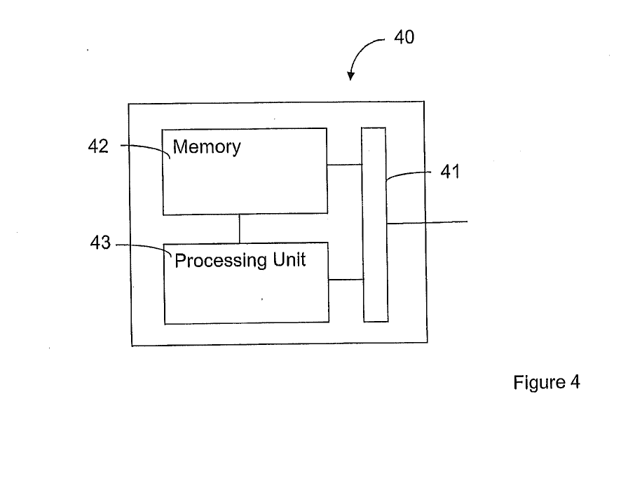

FIG. 4 discloses a network node 40 for performing one or more embodiments of the inventive method. Such a network node includes an interface 41, a memory 42 and a processor 43. The interface 41 is configured to receive localization related measures for a user equipment node at a localization measurement time. The memory 42 stores received localization related measures.

A trace of localization related measures are formed in the processor 43. The trace is based on a set of localization measurements stored in the memory 42, including at least a first localization related measurement at a first localization related measurement time (t1) and a second localization related measurement at a second localization related measurement time (t2) later than the first measurement time (t1). The processor 43 is also arranged to determine and associate accuracy-related information to the localization related measurements and to include the localization accuracies in the trace.

The processor 43 may include one or more data processing circuits, such as a general purpose and/or special purpose processor (e.g., microprocessor and/or digital signal processor). The processor 43 is configured to execute computer program instructions from functional modules in the memory 42 to perform at least some of the operations and methods described herein as being performed by a network node in accordance with one or more embodiments of the present invention.

The localization method are used to improve the accuracy for user equipment location estimates included with user equipment measurement reports and to provide a network based user equipment localization based on traces.

Other network nodes, UEs, and/or methods according to embodiments of the invention will be or become apparent to one with skill in the art upon review of the present drawings and description. It is intended that all such additional network nodes, UEs, and/or methods be included within this description, be within the scope of the present invention, and be protected by the accompanying claims. Moreover, it is intended that all embodiments disclosed herein can be implemented separately or combined in any way and/or combination.

1. A method in a network node in a wireless network for localization of a user equipment node at a specific time instant, the method comprising the steps of:
receiving one or more first localization related measures for the user equipment node at a first localization measurement time and one or more second localization related measures for the user equipment node at a second localization measurement time wherein a plurality of localization measurement times includes the first localization measurement time and the second localization measurement time, and wherein the specific time instant is within a time interval between the first localization measurement time and the second localization measurement time;
forming a trace of localization related measures for the user equipment node over the time interval from the first localization measurement time to the second localization measurement time; and
estimating the location of the user equipment node at the specific time instant from a localization related measure represented in the trace.

2. The method according to claim 1, further comprising the steps of:
determining one or more first localization accuracies for the one or more first localization related measures and determining one or more second localization accuracies for the one or more second localization related measures; and
including the one or more first localization accuracies and the one or more second localization accuracies in the trace of localization related measures.

3. The method according to claim 1, wherein the one or more first localization related measures and the one or more second localization related measures comprises received signal strength.

4. The method according to claim 1, wherein the one or more first localization related measures and the one or more second localization related measures comprise antenna information.

5. The method according to claim 2, wherein:
the one or more first localization related measures and the one or more second localization related measures comprises received signal strength and antenna information; and
the one or more first localization accuracies and the one or more second localization accuracies are derived from the received signal strength and the antenna information.

6. The method according to claim 1, wherein the one or more first localization related measures and the one or more second localization related measures includes a round-trip time estimate from one or more sectors associated with a base station.

7. The method according to claim 6, wherein the one or more first localization accuracies are derived from the round-trip time estimate associated with the base station.

8. The method according to claim 1, wherein the one or more first localization related measures and the one or more second localization related includes measures include a time difference of arrival report from a user equipment for a pairs of cells.

9. The method according to claim 8, wherein the one or more first localization accuracies and the one or more second localization accuracies are determined in response to a time synchronization estimation accuracy.

10. The method according to claim 9, wherein the one or more first localization accuracies and the one or more second localization accuracies are determined based on reported signal strength and quality per cell.

11. The method according to claim 1, further comprising the step of generating a one or more further localization related measures in the time interval from the first localization measurement time to the second localization measurement time.

12. A network node in a mobile network, the network node comprising:
an interface configured to receive user equipment node localization related measures at a localization measurement time;
a memory configured to store user equipment node localization related measures; and
a processor configured to form a trace of localization related measures for the user equipment node over a time interval from a first localization related measurement time to a second localization measurement time, and to estimate the location of the user equipment node at a single time instant from a localization related measure represented in the trace.

13. The network node according to claim 12, wherein:
the interface further is arranged to receive a user equipment node localization accuracy from one or more localization related measures; and
the processor is arranged to include the localization accuracy in the trace.

14. Use of a localization method according to claims 1 to generate a position estimate to be included with a user equipment measurement report.

15. The network node according to claim 13, wherein:
the one or more localization related measures comprise received signal strength and antenna information; and
the localization accuracy is derived from the received signal strength and the antenna information.
